(19) United States
(12) Patent Application Publication
(10) Pub. No.: US 2009/0107234 A1
(43) Pub. Date: Apr. 30, 2009

(54) System and method for measuring liquid level by image

(76) Inventors: Won Kim, Seoul (KR); Chi-Young Kim, Kyeonggi-do (KR); Dong-Gu Kim, Seoul (KR); Chan-Joo Lee, Incheon-si (KR); Seok-Hwan Hwang, Seoul (KR)

Correspondence Address: HAVERSTOCK & OWENS LLP, 162 N WOLFE ROAD, SUNNYVALE, CA, 94086, US

(21) Appl. No.: 11/921,152

(22) PCT Filed: Jul. 13, 2006
(86) PCT No.: PCT/KR2006/002749

§ 371 Date: Jun. 20, 2008

(30) Foreign Application Priority Data
Sep. 16, 2005 (KR) 10-2005-0086586

(51) Int. Cl. G01F 23/02

(52) U.S. Cl. 73/293

(57) ABSTRACT

The present invention relates to a system and a method for measuring liquid level by image, and more particularly to a system and a method for measuring liquid level by image, which is capable of measuring a liquid level accurately and automatically by photographing a proximity of liquid surface where a staff gage contacts the liquid using an image capturing apparatus, such as a camera, being located apart from the liquid to be measured, and by analyzing the photographed footage. The system for measuring liquid level by image comprises: a staff gage installed in the liquid; an image capturing part provided with a distance from where the staff gage is installed and capturing an image by photographing a proximity of liquid surface where the staff gage is installed; and a level recognition part controlling a capture of the image, wherein the level recognition part receives the image captured by the image capturing part and determines the liquid level.

### TECHNICAL FIELD

The present invention relates to a system and a method for measuring liquid level by image, and more particularly to a system and a method for measuring liquid level by image, which is capable of measuring a liquid level accurately and automatically by photographing a proximity of liquid surface where a staff gage is installed using an image capturing apparatus, such as a camera, being located apart from the liquid to be measured, and by analyzing the photographed image.

### BACKGROUND ART

Conventionally, there have been various methods of measuring a liquid level which are applicable to, as an example, liquid in a liquid storage tank, a water level of a dam, or a water level of a river. The simplest among those methods is to install a staff gage having a scale in the water and measure the water level by observing the scale with naked eye. Although such a method has an advantage that an observer can measure the water level at firsthand with naked eye, this method still has a disadvantage that it cannot verify the accuracy of the result due to the nature of measuring by observation with naked eye. Also, an automatic measurement cannot be realized in such a method.

Beside the method of measuring the liquid level by observing the scale with naked eye, there is a method of using a pressure sensor as one of methods of measuring the liquid level automatically. The method of measuring the liquid level using the pressure sensor comprises steps of positioning the pressure sensor in the liquid, measuring the pressure of the liquid, and converting the value of the pressure of the liquid applied to the sensor into the liquid level. However, the method of measuring the liquid level using such a pressure sensor has various problems such as movement of the pressure sensor placed in the liquid caused by the flow of the liquid being measured, contamination of the sensor by the liquid, and occurrence of an error caused by deteriorating sensitivity of the sensor to the variation of a liquid surface.

Also, there is a method of using ultrasonic waves or a radar sensor as an another method of measuring the liquid level automatically, excluding the method of measuring the liquid level directly with naked eye. Although this method has an advantage that it can measure the liquid level automatically, it has a disadvantage that the accuracy of the result may deteriorate by error of the sensor increasing in case that the surface of the liquid changes irregularly or the temperature of the liquid varies.

As an another conventional method of measuring the liquid level, there is a method of measuring the liquid level by providing a float provided in a structure such as a stilling well for stabilizing the liquid. Although such a method has an advantage that the liquid level can be measured with considerable accuracy as the stilling well stabilizes the surface of the liquid held inside, it still has a disadvantage that the variation of the liquid level may not be reflected sensitively because debris are likely to get accumulated inside the structure or the stilling well.

### DISCLOSURE OF INVENTION

### Technical Problem

As mentioned above, the conventional methods of measuring the liquid level and apparatuses thereof have a disadvantage that a sensor or a structure has to be provided to contact liquid, which causes the sensor or mechanic device contacting the liquid to be broken down or malfunctioning.

Also, in case where a central monitoring center being responsible for verifying the measured value is located remote from a measuring site, such conventional methods of measuring the liquid level and apparatuses thereof have another disadvantage that accuracy of the liquid level being measured cannot be verified because the measuring site cannot be observed with naked eye.

Accordingly, there exists a demand for a system or a method capable of measuring the liquid level more accurately and more stably by modifying the conventional methods of measuring the liquid level.

### Technical Solution

An objective of the present invention is achieved by providing a system and a method for measuring liquid level by image, which is capable of measuring a liquid level accurately and automatically by photographing a proximity of liquid surface where a staff gage is installed using an image capturing apparatus, such as a camera, being located apart from the liquid to be measured, and by analyzing the photographed Image.

Another objective of the present invention is achieved by providing a system and a method for measuring liquid level by image, which enables a central monitoring device to verify accuracy of the measured liquid level by receiving both of a measured value of the liquid level and a photographed image taken at a measuring site at the same time.

### ADVANTAGEOUS EFFECTS

The present invention has advantageous effects such as measuring accurately a liquid level without contacting the liquid and measuring the level of liquid surface accurately and stably by detecting any error that may occur by transmitting the image of the liquid surface to a monitoring administrator, by way of overcoming disadvantages of a conventional apparatus or method for measuring liquid level, wherein such disadvantages include an error that can occur by the influence of a sensor or a structure required for measuring the liquid level, an error that can occur due to a sensor positioned in the liquid, difficulty of maintenance, and an inability to verify the accuracy by observing the staff gage with the naked eyes from the remote site.

### BRIEF DESCRIPTION OF THE DRAWINGS

These and/or other aspects and advantages of the present invention will become apparent and more readily appreciated from the following description of the aspects, taken in conjunction with the accompany drawings of which:

FIG. 1 is a schematic view of a system for measuring liquid level by image according to an embodiment of the present invention.

FIG. 2 is a block diagram illustrating an image capturing part and a level recognition part of the system for measuring liquid level by image according to the embodiment of the present invention.

FIG. 3 illustrates an example of a staff gage of the system for measuring liquid level by image according to the embodiment of the present invention.

FIG. 4 illustrates an exemplary state of the staff gage shown in FIG. 3 being installed in liquid to be measured.

FIG. 5A schematically illustrates an exemplary standard image being used as a criterion in a step of comparing.

FIG. 5B schematically illustrates an exemplary actual photographed image photographed by a camera and showing a predetermined photographing domain of the proximity of liquid surface where the staff gage is installed.

FIG. 5C schematically illustrates an image re-photographed after the camera is tilted.

FIG. 6 is a flow chart of a method for measuring the liquid level by image according to an embodiment of the present invention.

FIG. 7 is a flow chart illustrating specified steps for the step of capturing an image shown in FIG. 6.

FIG. 8 is a flow chart illustrating specific steps for the step of determining a liquid level shown in FIG. 6.

### BEST MODE FOR CARRYING OUT THE INVENTION

It is an aspect of the present invention to provide a system for measuring liquid level by image, characterized by comprising: a staff gage being installed in the liquid; an image capturing part provided apart from where the staff gage is installed and capturing an image by photographing a proximity of liquid surface where the staff gage is installed; and a level recognition part controlling the image capturing part to capture the image, wherein the level recognition part determines the liquid level by receiving the image captured by the image capturing part.

Additional aspects and advantages of the invention will be set forth in part in the description which follows and, in part, will be obvious from the description, or may be learned by practice of the invention.

### MODE FOR THE INVENTION

An objective of the present invention is achieved by providing a system for measuring liquid level by image, comprising: a staff gage installed in the liquid; an image capturing part provided apart from where the staff gage is installed and capturing an image by photographing a proximity of liquid surface of the liquid where the staff gage is installed; and a level recognition part controlling the image capturing part to capture of the image, wherein the level recognition part receives the image captured by the image capturing part and determines the liquid level.

The image capturing part comprises a camera photographing the proximity of liquid surface where the staff gage is installed and a fan-tilt rotating the camera vertically and horizontally. The level recognition part comprises an image grabber receiving an image photographed by the camera, a main control part determining the liquid level by receiving the photographed image from the image grabber, and a trigger signal control module sending a trigger signal to the camera based on a control of the main control part and sending a tilting signal to the fan-tilt.

The main control part receives an image signal photographed by the camera from the image grabber to determine a gradient of color saturation of the photographed image. Then, the main control part compares the gradient of color saturation with a predetermined first threshold value of the gradient of color saturation. In case that the gradient of color saturation of the photographed image is smaller than the first threshold value, the trigger signal control module controls the fan-tilt to rotate the camera and sends the trigger signal to the camera again.

Also, The main control part receives the image photographed by the camera from the image grabber in order to recognize liquid surface by generating a digitized image from the image based on the color saturation. Then the main control part recognizes numerals inscribed on the staff gage from the digitized image and determines a minimum numeral among the recognized numerals. The main control part recognizes the number of pixels that consists vertical distance between the liquid surface and the numeral on the staff gage corresponding to the minimum number so that it can calculate a distance between the minimum numeral determined from the digitized image and the liquid surface. Accordingly, the liquid level can be determined by subtracting the calculated distance from the minimum numeral.

The main control part compares the digitized image based on the color saturation with a predetermined second threshold value so that a boundary portion exceeding the second threshold value can be recognized as the liquid surface. Herein, the main control part separates an area containing continuous numerals having values of a certain range from the digitized image and compares font of the continuous numerals with font data stored in advance, in order to recognize the numerals.

The main control part controls the trigger signal control module so that the camera can photograph at least 3 continuous numerals. However, in case that the numerals recognized from the digitized image are not the at least 3 continuous numerals, it is preferable that it is recognized as an error so that the main control part controls the trigger signal control module to trigger the camera to photograph again.

Also, the main control part compares the number of pixels of a vertical distance between the liquid surface recognized by the digitized image and the numeral on the staff gage corresponding to the minimum numeral with the number of pixels between adjacent numerals on the staff gage. In this way, the main control part calculates the distance between the minimum numeral and the liquid surface.

Also, it is preferable that the image capturing part further comprise a lighting device being controlled by the trigger signal control module. In case that the color saturation of the image received from the image grabber is smaller than a predetermined criterion value, the controlling part preferably controls the trigger signal control module to trigger the lighting device and to send a re-trigger signal to the camera.

Also, as the staff gage is formed with the numerals and supplementary scales filling spaces between the numerals, the liquid level preferably can be measured by observing the image photographed by the camera with naked eye. It is preferable that the level recognition part further comprise a transmission means being controlled by the controlling part so that the transmission means transmit the image photographed by the camera and the liquid level determined by the main control part to a central monitoring device located remote from the measuring site according to the control of the main control part.

As an example to which the present invention is not limited, the liquid level may be one of a liquid level in a liquid storage tank, a water level of a dam, and a water level of a river.

Another objective of the present invention is achieved by providing a method for measuring liquid level by image, comprising: a step of installing a staff gage in the liquid; a step of capturing an image by photographing a proximity of liquid surface where the staff gage is installed using a camera provided apart from where the staff gage is installed; and a step of determining a liquid level from the captured image.

Herein, the step of capturing the image by photographing the proximity of liquid surface may comprise: a step of photographing a proximity of liquid surface where the staff gage is installed using the camera; a step of determining a gradient of color saturation of the full photographed image of the proximity and comparing the gradient of color saturation with a predetermined first threshold value of the gradient of color saturation; a step of re-photographing the proximity by tilting the camera if the gradient of color saturation of the photographed image of the proximity is smaller than the first threshold value; and a step of deciding that the photographed image contains the proximity of liquid surface where the staff gage contacts the liquid if it is determined from the step of comparing that the gradient of color saturation of the photographed image of the proximity is greater than the first threshold value.

Also, the step of determining the liquid level may comprise: a step of recognizing a liquid surface by generating a digitized image based on the color saturation from the image captured in the step of capturing the image; a step of recognizing numerals inscribed on the staff gage from the digitized image and determining a minimum numeral among the recognized numerals; a step of calculating a distance between the minimum numeral determined from the digitized image and the liquid surface by counting the number of pixels of a vertical distance between the liquid surface and the numeral on the staff gage corresponding to the minimum numeral; and a step of determining the liquid level by subtracting the calculated distance calculated in the step of calculating the distance from the minimum numeral determined in the step of determining the minimum numeral.

Hereinafter, preferred embodiments according to the present invention will be described in reference to the drawings, as an example.

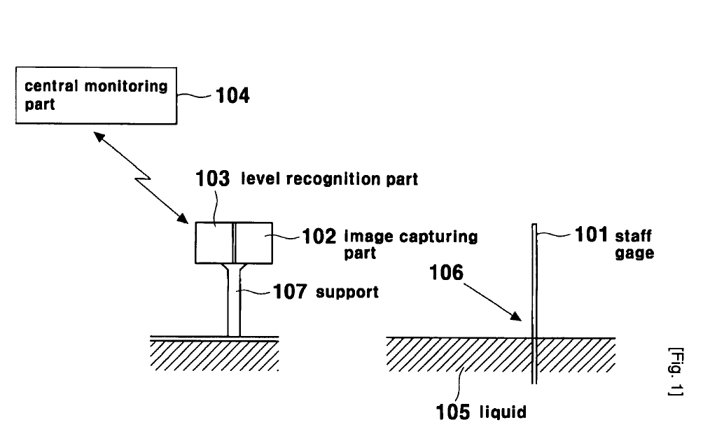

FIG. 1 is a schematic view of a system for measuring liquid level by image according to an embodiment of the present invention.

As shown in FIG. 1, the system for measuring liquid level by image according to the embodiment of the present invention, which is installed on liquid 105, comprises: a staff gage 101 inscribed with numerals of a primary scale and a supplementary scale for measuring a liquid level; an image capturing part 102 installed on a support 107 located apart with a distance from the staff gage 101 and capturing an image by photographing a proximity 106 where the staff gage 101 is installed; and a level recognition part 103 being connected to the image capturing part 102 to control the image capturing part 102 to capture images and determining a level of the liquid 105 by receiving the images captured by the image capturing part 102.

Also, as shown in FIG. 1, the system for measuring liquid level by image according to the embodiment of the present invention may comprise a central monitoring device 104 being located remote and receiving the level of the liquid 105 recognized by the level recognition part 103 and the images captured by the image capturing part 102 by using a cable or wireless transmission means

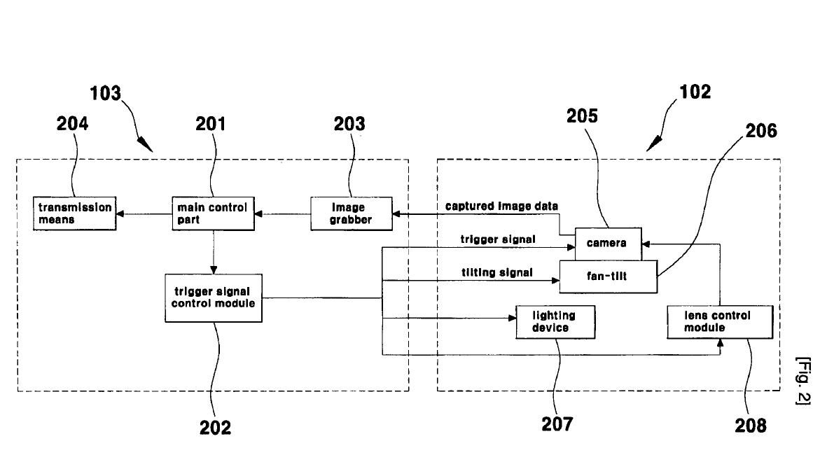

FIG. 2 is a block diagram illustrating the image capturing part 102 and the level recognition part 103 of the system for measuring liquid level by image according to the embodiment of the present invention.

As shown in FIG. 2, the image capturing part 102 comprises a camera 205 photographing the proximity 106 where the staff gage 101 is installed, a fan-tilt 206 rotating the camera 205 vertically and horizontally, a lens control module 208 for zooming and focusing the camera 205, and a lighting device 207 for adjusting illuminance of the proximity being photographed.

Also, the level recognition part 103 shown in FIG. 2 comprises: an image grabber 203 receiving an image photographed by the camera 205; a main control part 201 determining the level of liquid being measured by receiving the image photographed by the camera 205; a trigger signal control module 202 sending a trigger signal to the camera 205, a tilting signal to the fan-tilt 206 for rotating the camera 205 vertically and horizontally, and a control signal to the lens control module 208 controlling a lens of the camera to enhance photographing the proximity 106 near the staff gage 101 in accordance with the control of the main control part 201; and a transmission means 204 transmitting the photographed image and liquid level data from the main control part 204 to the central monitoring device 104.

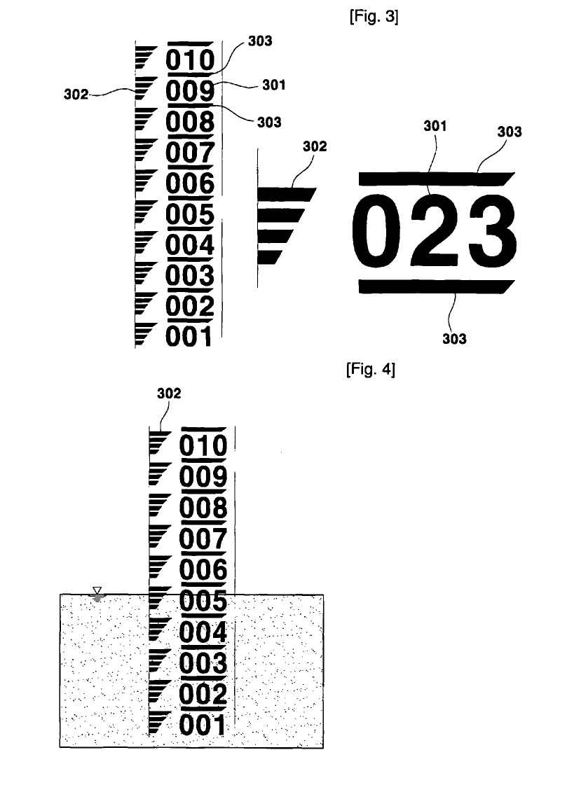

FIG. 3 illustrates an example of the staff gage of the system for measuring liquid level by image according to the embodiment of the present invention.

As shown in FIG. 3, the staff gage 101 installed in the liquid (which is, generally, installed to submerge in the liquid perpendicular to the liquid surface) comprises numerals 301 as a primary scale and supplementary scales 302, wherein boundary lines 303 are inscribed between the numerals 301. A distance between the boundary lines 303 may be a predetermined distance such as 10 cm, etc. Also, the numeral 301 inscribed on the staff gage as a primary scale should be preferably written in a specific font that can be recognized by the main control part 201 of the level recognition part 103.

FIG. 4 illustrates an exemplary state of the staff gage 101 shown in FIG. 3 being installed in the liquid 105. As shown in the drawing, the staff gage 101 is preferably installed to submerge in the liquid 105 to be measured in perpendicular to the surface of the liquid so that measurement error can be minimized.

Hereinbelow, a process of determining the liquid level will be described beginning with a description on a step of capturing image using the system for measuring liquid level by image.

When the main control part 201 of the level recognition part 103 controls the trigger signal control module 202 to send the trigger signal to the camera 205 of the image capturing part 102, the camera 205 begins to photograph a predetermined photographing domain of the proximity of liquid surface where the staff gage 101 is installed. The camera 205 transmits the photographed image as captured image data to the image grabber 203, then the image grabber 203 transmits the captured image data received from the camera 205 to the main control part 201.

The main control part 201 begins to analyze the captured image data of the camera 205 received from the image grabber 203. In other words, the main control part 201 determines the gradient of the color saturation of the full image photographed by the camera 205.

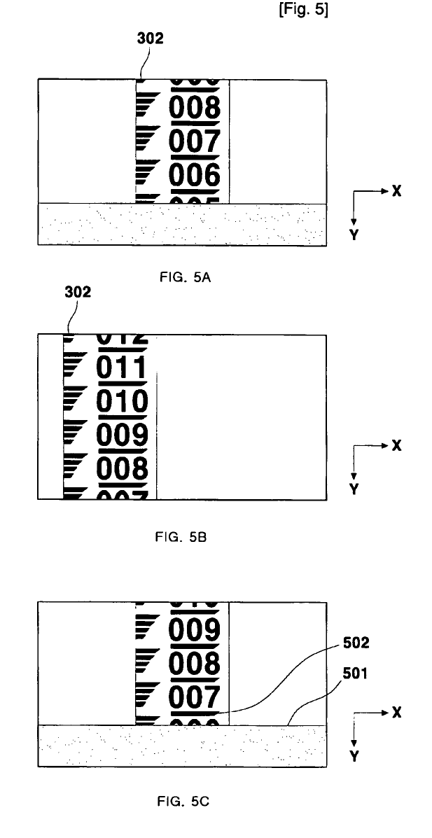

FIG. 5A illustrates an exemplary standard image stored in the main control part 201, and FIG. 5B illustrates an exemplary actual photographed image photographed by the camera and showing a predetermined photographing domain of the proximity of liquid surface where the staff gage 101 is installed.

Before analyzing the actual photographed image photographed by the camera 205 as shown in FIG. 5B, the main control part 201 determines gradients of color saturation along X-axis and Y-axis for each pixel of the standard image shown in FIG. 5A in advance, in order to establish a tolerable threshold or a threshold range of the standard gradient of color saturation for each pixel of the image along X-axis and Y-axis. The threshold or the threshold range of the gradient of color saturation may be stored in the main control part 201 in the form of table for X-axis and Y-axis of each pixel.

The main control part 201 analyzes the actual photographed image by receiving the actual photographed image shown in FIG. 5B from the image grabber 203. In other words, the main control part 201 determines the gradients of color saturation along X-axis and Y-axis for each pixel of the actual photographed image shown in the FIG. 5B, and compares the determined gradients with the threshold values of the gradients of the color saturation which was predetermined for the standard image shown in FIG. 5A. If the step of analyzing the image determines that the analyzed data of the actual photographed image is deviating from the predetermined threshold of the gradient of color saturation, the main control part 201 determines displacements along X-axis and Y-axis of 2 dimensional image by comparing the gradient of the actual photographed image with the predetermined threshold, so that the gradient of the actual photographed image falls within the threshold. Then, the main control part 201 determines a 3 dimensional displacement of the camera 205 in order to get the displacements along X-axis and Y-axis of 2 dimensional image. Herein, the 3 dimensional displacement of the camera 205 may include rotational movements in vertical and horizontal directions.

After completing such an analysis on the image photographed by the camera 205, the main control part 201 controls the fan-tilt 206 to move the camera 205 by means of the trigger signal control module 202, in order to control the 3 dimensional movement according to the determined displacements along X-axis and Y-axis of the 2 dimensional image.

In addition, the main control part 201 may control triggering of the lighting device 207 and the strength of the light by means of the trigger signal control module 202 when the color saturation of the photographed image is below a predetermined criterion value due to the low illuminance of the photographed image. Accordingly, it is preferable that the lighting device of the system for measuring liquid level by image according to the embodiment of the present invention can control the strength of the illuminance.

If adjustments are made to re-photograph in a manner described above, the main control part 201 sends a re-trigger signal to the camera 205 by means of the trigger signal control module 202. Accordingly, the camera 205 re-photographs the proximity and transmits the photographed image to the main control part 201 through the image grabber 203. Then, the main control part 201 compares the image data received again with the standard image shown in FIG. 5A by implementing the same procedure described above in order to decide whether to re-photograph using the camera 205 or not. FIG. 5C illustrates an example of an image re-photographed after the camera 205 is moved by an operation of the fan-tilt 206. If the gradient of color saturation of the re-photographed image falls within the threshold of the color saturation of the standard image shown in FIG. 5A, the main control part 201 implements the procedure for determining the liquid level.

Specifically, when the main control part 201 determines that the gradient of color saturation of the re-photographed image falls within the threshold of the color saturation of the standard image shown in FIG. 5A, the main control part 201 recognizes the surface of the liquid by generating the digitized image based on the color saturation of each pixel from the image photographed by the camera 205. To describe in detail in reference to FIG. 5C, the main control part 201 generates the digitized image of each pixel based on the color saturation by referring to the image shown in FIG. 5C. Then, the main control part 201 recognizes a portion corresponding to a pixel having a gradient of a color saturation exceeding the predetermined threshold as the surface 501 of the liquid while detecting gradient of the color saturation along Y-axis.

Accordingly, the main control part 201 recognizes the numeral inscribed on the staff gage 101 from the digitized image based on the color saturation by referring to the image shown in FIG. 5C. Specifically, the main control part 201 separates a portion containing continuous numerals having values of a certain range from the digitized image. In reference to FIG. 5C, the main control part 201 separates numerals 007, 008, and 009 as the portion containing continuous numerals having values of a certain range. The numerals such as 007, 008, and 009 separated from the digitized image are compared to font data of numerals stored in advance in the main control part 201. As described briefly above, the numerals inscribed on the staff gage 101 have a specific font, wherein the specific font is prepared corresponding to the font of numerals stored in the main control part 201. Accordingly, the main control part 201 can recognize the numerals separated from the digitized image according to the font of numeral stored in advance. As the numerals are recognized from the digitized image, the main control part 201 determines the minimum value among the recognized numerals. In the image shown in FIG. 5C, the minimum value will be 007.

Accordingly, the main control part 201 recognizes a boundary line 502 on bottom of 007, which is the numeral corresponding to the minimum value from the digitized image based on the color saturation shown in FIG. 5C. The recognition of the boundary line 502 is implemented in the same manner done for the recognition of the surface 501 of the liquid described earlier. After recognizing the boundary line 502 on bottom of the numeral corresponding to the minimum value, the number of pixels between the boundary line 502 and the recognized surface 501 of the liquid is counted. Also, the number of pixels between the boundary lines located between the recognized numerals is counted as well. In this case, it is preferable to count the number of pixels between boundary lines on top and bottom of 007, which is the minimum value, in consideration of distortion of the image. After recognizing the number of pixels as described above, a distance from the boundary line 502 to the surface 501 of the liquid is calculated by comparing the number of pixels between the boundary line 502 and the surface 501 of the liquid with the number of pixels between boundary lines between the numbers. As an example, if it is assumed that the distance between the boundary lines of the staff gage 101 is 10 cm and the counted number of pixels between the boundary lines on top and bottom of the numeral is 100 and the number of pixels between the boundary line 502 and the surface 501 of the liquid is 40, the distance from the boundary line 502 to the surface 501 of the liquid is determined to be 4 cm.

After calculating the minimum value and the distance from the boundary line on bottom of the minimum value to the liquid surface from the digitized image, the main control part 201 determines the liquid level from the image photographed by the camera, by subtracting the distance between the boundary line and the liquid surface from the minimum value. As an example, in case of FIG. 5C, the liquid level can be calculated to be 66 cm by subtracting 4 cm, the distance between the boundary line and the liquid surface, from the minimum value of 7 indicating 70 cm.

Also, the numerals of the staff gage 101 contained in the image photographed by the camera 205 preferably should be at least 3 continuous numerals. In case that the number of the numerals photographed and recognized by the main control part 201 is smaller than 3 of continuous numerals, the main control part 201 controls the lens control module 208 through the trigger signal control module 202 so that the number of the numerals on the staff gage 101 photographed can be at least more than 3. In this way, the main control part 201 can allow the camera to photograph more than 3 numerals on the staff gage 101. In case that the numerals recognized from the digitized image generated from the photographed image are not at least 3 continuous numerals, the main control part 201 determines that an error occurred and transmits a re-trigger signal to the camera 203 through the trigger signal control module 202.

In addition, as the staff gage 101 is inscribed with the supplementary scale as well as the numerals of primry scale as described above, it is also possible to read the liquid level from the image photographed by the camera 205 with naked eye.

In this case, the level recognition part 103 transmits the liquid level data acquired through the procedure described above and the image photographed by the camera 205 to the central monitoring device 104 by means of transmission means 204. Herein, the central monitoring device 104 compares the photographed image and the measured liquid level data transmitted from the system for measuring liquid level, in order to verify the accuracy of the system for measuring liquid level in measuring the liquid level without an error.

The system for measuring liquid level by image according to the embodiment of the present invention may be applied to cases of measuring a liquid level in a liquid storage tank, a water level of a dam, and a water level of a river, as an example.

Additionally, it is possible to replace the color saturation mentioned above with the gray level, and to replace the digitized image based on the color saturation with the binary image generated based on a specific threshold value.

Hereinafter, a method for measuring liquid level by image will be described according to an embodiment of the present invention.

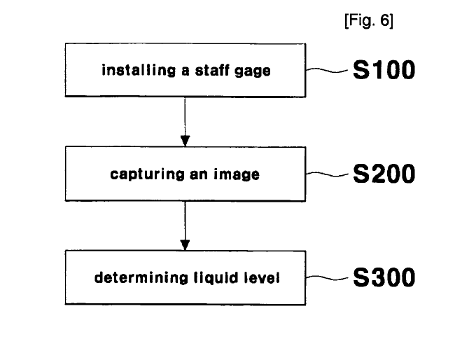

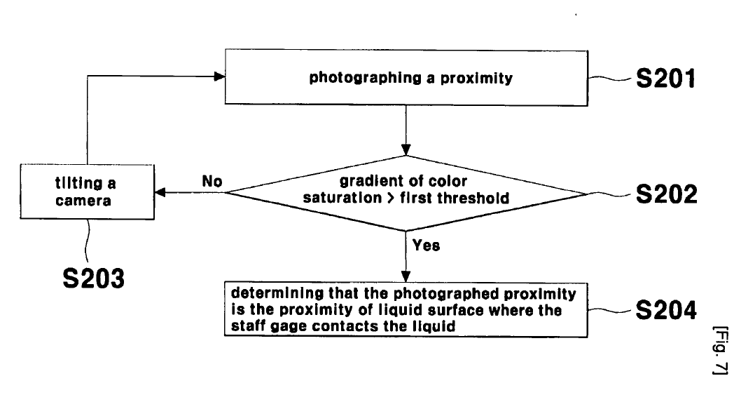

FIG. 6 is a flow chart of the method for measuring the liquid level by image according to the embodiment of the present invention.

As shown in FIG. 6, the method for measuring the liquid level by image according to the embodiment of the present invention comprises: a step S100 of installing a staff gage in the liquid to be measured; a step S200 of capturing an image by photographing a proximity of liquid surface where the staff gage is installed using a camera being located apart from the proximity of liquid surface where the staff gage is installed; and a step S300 of determining the level of the liquid to be measured from the captured image.

Hereinbelow, each step will be described in detail.

FIG. 7 is a flow chart illustrating specified steps for the step S200 of capturing an image described in FIG. 6.

As shown in FIG. 7, the step of capturing an image comprises: a step S201 of photographing a proximity; and a step S202 of determining a gradient of color saturation of the image captured in the step S201 and comparing the gradient of the determined color saturation with a predetermined first threshold value. Herein, the first threshold value predetermined in the step S202 can be set according to the standard image shown in FIG. 5A. If it is determined that the gradient of the color saturation does not exceed the predetermined first threshold value in step S202, the step S202 goes to a step S203 of tilting the camera, then the step S202 flows to the step S201 to photograph the proximity of liquid surface where the staff gage is installed using the camera. If it is determined that the gradient of the color saturation of the image photographed in the step S202 exceeds the predetermined first threshold value, the step S202 goes to the step S204 of determining that the photographed proximity contains the proximity of liquid surface where the staff gage contacts the liquid. Then the step S204 flows to the step S300 of determining the liquid level shown in FIG. 6.

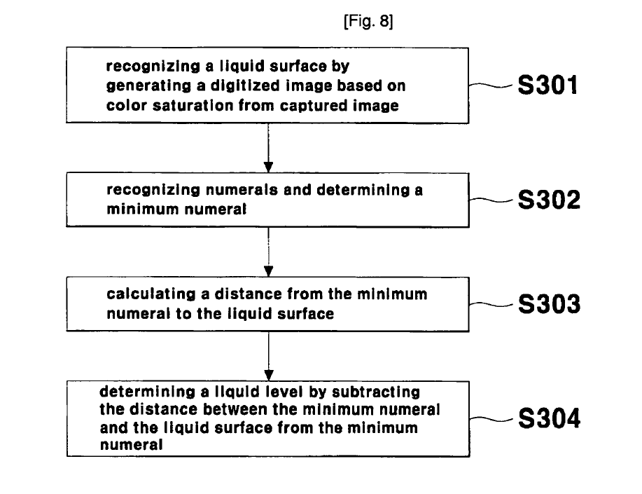

FIG. 8 is a flow chart illustrating specific steps for the step of determining the liquid level shown in FIG. 6.

As shown in FIG. 8, the step S300 of determining the liquid level starts from a step S301 of recognizing a liquid surface by recognizing an digitized image based on the color saturation from the image captured in the step S200. In detail, the step S301 sets a second threshold value from the digitized image based on the color saturation in order to recognized a portion exceeding the second threshold value as the liquid surface. In this step, the second threshold value can be set using the standard image shown in FIG. 5A.

In step S302, the numeral inscribed on the staff gage in the captured image from the digitized image based on the color saturation in the step S301 is recognized and the minimum value is determined. Specifically, in the step S302, a portion containing continuous numerals having values of a certain range is separated from the digitized image based on the color saturation, and the font of this continuous numerals is compared with the font data stored in advance. In this way, the numerals are recognized and the minimum value of the recognized numerals is determined.

After the minimum value is determined by recognizing the numerals in the step S302, a distance from the recognized minimum value to the liquid surface is calculated in the step S303. Specifically, in the step S303, the distance from the minimum value to the liquid surface is calculated by comparing the number of pixels between the liquid surface recognized in the step S301 and the numeral corresponding to the minimum value determined in the step S302 with the number of pixels between the adjacent numerals on the staff gage.

Also, the level of the liquid to be measured is determined in the step S304. Specifically, the liquid level is determined by subtracting the distance calculated in the step S303 from the minimum value determined in the step S302.

The step S200 of capturing the image shown in FIG. 6 comprises a step of photographing at least 3 continuous numerals on the staff gage. The step S302 of recognizing the numerals and determining the minimum value shown in FIG. 8 preferably comprises a step of returning to the step S200 of capturing the image shown in FIG. 6 if the numerals recognized from the digitized image based on the color saturation are not at least 3 continuous numerals, which is determined to be a case of an error. However, these steps are necessary for detecting an error that may occur during the liquid level measuring procedure in advance.

Also, the step S200 of capturing the image shown in FIG. 6 may comprises a step of switching a lighting device on/off. This is for the purpose of keeping a proper level of color saturation when illuminance is too low.

In addition, the method for measuring the liquid level by image according to the embodiment of the present invention may further comprise a step of transmitting the image captured in the step S200 and the liquid level determined in the step S304 to the central monitoring device being located remote. This is for the purpose of enabling the central monitoring device to verify the accuracy of the liquid level measured according to the method for measuring the liquid level by image according to the embodiment of the present invention. In other words, the central monitoring device compares the liquid level measured by observing the image with naked eyes through such procedures with the data actually measured, in order to detect an error of the method for measuring the liquid level by image according to the embodiment of the present invention.

Although a few embodiments of the present invention have been shown and described, the preferred embodiments described so far should be understood as an examples. In other words, it will be appreciated by those skilled in the art that changes may be made in these aspects without departing from the principles and spirit of the invention, the scope of which is defined in the appended claims and their equivalents.

1. A system for measuring liquid level by image, characterized by comprising:
a staff gage being installed in liquid;
an image capturing part provided apart from where the staff gage is installed and capturing an image by photographing a proximity of liquid surface where the staff gage is installed; and
a level recognition part controlling the image capturing part to capture the image, wherein the level recognition part determines the liquid level by receiving the image captured by the image capturing part.

2. The system for measuring liquid level by image according to claim 1, which is characterized in that
the image capturing part comprises:
a camera photographing the proximity of liquid surface where the staff gage is installed; and
a fan-tilt rotating the camera vertically and horizontally, and the level recognition part comprises:
an image grabber receiving the image photographed by the camera;
a main control part determining the liquid level by receiving the photographed image from the image grabber; and
a trigger signal control module providing a trigger signal to the camera and a tilting signal to the fan-tilt according to a control of the main control part.

3. The system for measuring liquid level by image according to claim 2, which is characterized in that
the main control part determines a gradient of color saturation of the photographed image by receiving an image signal photographed by the camera from the image grabber, the main control part compares the gradient of color saturation with a predetermined first threshold value of the gradient of color saturation, and
the main control part controls the fan-tilt to rotate the camera through the trigger signal control module and provides the trigger signal to the camera again if the gradient of color saturation of the photographed image is smaller than the first threshold value.

4. The system for measuring liquid level by image according to claim 2, which is characterized in that
the main control part recognizes a liquid surface by receiving the image photographed by the camera from the image grabber and generating a digitized image based on the color saturation from the image,
the main control part recognizes numerals inscribed on the staff gage from the digitized image and determines a minimum numeral among recognized numerals, the main control part calculates a distance from the minimum numeral determined from the digitized image to the liquid surface by recognizing the number of pixels of a vertical distance between the liquid surface and a numeral corresponding to the minimum numeral, and
the main control part determines the liquid level by subtracting the calculated distance from the minimum numeral.

5. The system for measuring liquid level by image according to claim 4, which is characterized in that
the main control part compares the digitized image based on the color saturation with a predetermined second threshold value and recognizes a boundary portion exceeding the second threshold value as the liquid surface.

6. The system for measuring liquid level by image according to claim 4, the main control part separates a portion containing continuous numerals having values of a certain range from the digitized image and recognizes a numeral by comparing the font of the continuous numerals with the font data stored in advance.

7. The system for measuring liquid level by image according to claim 4, which is characterized in that
the main control part calculates the distance from the minimum numeral to the liquid surface by comparing the number of pixels of the vertical distance between the liquid surface recognized from the digitized image and the numeral corresponding to the minimum numeral with the number of pixels between adjacent numerals on the staff gage.

8. The system for measuring liquid level by image according to claim 4, which is characterized in that
the main control part controls the camera to photograph at least 3 continuous numerals by controlling the trigger signal control module, and
the main control part recognizes that an error occurs in case that the numerals recognized from the digitized image are not at least 3 continuous numerals, and controls the camera to photograph again through the trigger signal control module.

9. The system for measuring liquid level by image according to claim 4, which is characterized in that
the image capturing part further comprises a lighting device being controlled by the trigger signal control module,
wherein the main control part controls the trigger signal control module to trigger the lighting device and sends a re-trigger signal to the camera when the color saturation of the image received from the image grabber is below a predetermined criterion value.

10. The system for measuring liquid level by image according to claim 1, which is characterized in that
the staff gage is formed with a supplementary scale as well as numerals indicating water level so that the liquid level can be measured by observing the image photographed by the camera with naked eyes.

11. The system for measuring liquid level by image according to claim 1, which is characterized in that
the level recognition part further comprises a transmission means being controlled by the main control part,
wherein the transmission means transmits the image photographed by the camera and the liquid level determined by the main control part to a central monitoring device being located remote according to a control of the main control part.

12. The system for measuring liquid level by image according to claim 1, which is characterized in that
the liquid level is one of a liquid level in a liquid storage tank, a water level of a dam, and a water level of a river.

13. A method for measuring liquid level by image, comprising:
a first step of installing a staff gage in liquid;
a second step of capturing an image by photographing a proximity of liquid surface where the staff gage is installed using a camera provided apart from where the staff gage is installed; and
a third step of determining a liquid level from the captured image.

14. The method for measuring liquid level by image according to claim 13, which is characterized in that the second step comprises:
a step of photographing the proximity of liquid surface where the staff gage is installed using the camera;
a step of determining a gradient of color saturation of the photographed image of the proximity and comparing the determined gradient of color saturation with a predetermined first threshold value of the gradient of color saturation;
a step of tilting the camera and photographing again if it is determined that the gradient of color saturation of the photographed image of the proximity is smaller than the first threshold value in the step of comparing; and
a step of determining that the photographed image contains the proximity of liquid surface where the staff gage contacts the liquid if it is determined that the gradient of color saturation of the photographed image of the proximity is greater than the first threshold value in the step of comparing.

15. The method for measuring liquid level by image according to claim 13, which is characterized in that the third step comprises:
a fourth step of recognizing a liquid surface by generating a digitized image based on the color saturation from the image captured in the second step;
a fifth step of recognizing numerals inscribed on the staff gage from the digitized image and determining a minimum numeral among the recognized numerals;
a sixth step of calculating a distance from the minimum numeral determined from the digitized image to the liquid surface by recognizing the number of pixels of a vertical distance between the liquid surface and a numeral corresponding to the minimum numeral; and
a seventh step of determining the liquid level by subtracting the distance calculated in the sixth step from the minimum numeral determined in the fifth step.

16. The method for measuring liquid level by image according to claim 15, which is characterized in that
the fourth step comprises a step of setting a second threshold value from the digitized image based on the color saturation and recognizing a boundary portion exceeding the second threshold value as the liquid surface.

17. The method for measuring liquid level by image according to claim 15, which is characterized in that
the fifth step comprises a step of separating a portion containing continuous numerals having values of a certain range from the digitized image based on the color saturation and recognizing numerals by comparing the font of the continuous numerals with the font data stored in advance.

18. The method for measuring liquid level by image according to claim 15, which is characterized in that
the sixth step comprises a step of calculating a distance from the minimum numeral to the liquid surface by comparing the number of pixels between the liquid surface recognized in the fourth step and the numeral corresponding to the minimum numeral determined in the fifth step with the number of pixels between the adjacent numerals on the staff gage.

19. The method for measuring liquid level by image according to claim 17, which is characterized in that
the second step comprises a step of photographing at least 3 continuous numerals on the staff gage; and
the fifth step comprises a step of returning to the second step in case of error that the numerals recognized from the digitized image are not at least 3 continuous numerals.

20. The method for measuring liquid level by image according to claim 14, which is characterized in that
the second step comprises a step of switching a lighting device on/off in consideration of illuminance.

21. The method for measuring liquid level by image according to claim 13, which is characterized in that
the staff gage is formed with numerals indicating water level and supplementary scales between the numerals so that the liquid level can be measured by observing the image photographed by the camera with naked eyes.

22. The method for measuring liquid level by image according to claim 14, further comprising an eighth step of transmitting the image captured in the second step and the liquid level determined in the seventh step to a central monitoring device being located remote.

23. The method for measuring liquid level by image according to claim 13, which is characterized in that
the liquid level is one of a liquid level in a liquid storage tank, a water level of a dam, and a water level of a river.

24. The method for measuring liquid level by image according to claim 15, further comprising an eighth step of transmitting the image captured in the second step and the liquid level determined in the seventh step to a central monitoring device being located remote.
